(19) United States
(12) Patent Application Publication
(10) Pub. No.: US 2025/0170751 A1
(43) Pub. Date: May 29, 2025

(54) CERAMIC MATRIX COMPOSITE STRUCTURES AND METHODS FOR MANUFACTURE THEREOF

(71) Applicant: The Boeing Company, Arlington, VA (US)

(72) Inventors: Erik N. Wienhold, Seattle, WA (US); Sangvavann Heng, Buena Park, CA (US); Michael Trowbridge, Long Beach, CA (US); Brian J. Smith, Seattle, WA (US); Brice A. Johnson, Toledo, WA (US); Lisa C. Zgherea, Auburn, WA (US); Christopher R. Brown, Seattle, WA (US); Ricardo A. Fritzke, Sammamish, WA (US)

(73) Assignee: The Boeing Company, Arlington, VA (US)

(21) Appl. No.: 18/892,800

(22) Filed: Sep. 23, 2024

Related U.S. Application Data
(60) Provisional application No. 63/603,915, filed on Nov. 29, 2023.

(51) Int. Cl. B28B 3/00; B28B 1/00; B28B 17/00; C04B 35/80

(52) U.S. Cl. CPC B28B 3/006; B28B 1/002; B28B 17/0081; C04B 35/80

(57) ABSTRACT

An electronically-controlled method is provided for manufacturing a ceramic matrix composite structure with a desired shape. The electronically-controlled method comprises processing at a first location a plurality of ceramic matrix composite plies to form a stack of the plurality of ceramic matrix composite plies. The electronically-controlled method also comprises transporting the stack of plurality of ceramic matrix composite plies from the first location to a second location which is remote from the first location. The electronically-controlled method further comprises processing at the second location the stack of plurality of ceramic matrix composite plies to provide the ceramic matrix composite structure with the desired shape.

### PRIORITY

This application claims priority from U.S. Ser. No. 63/603,915 filed on Nov. 29, 2023, the entire contents of which are incorporated herein by reference.

### FIELD

The present application relates to composite structures and, more particularly, to ceramic matrix composite structures and methods for manufacture thereof.

### BACKGROUND

Ceramic matrix composites have different tack and texture than polymer matrix composites that require different methods of processing. Ceramic fibers of ceramic matrix composites are more brittle and stiffer than carbon fibers of polymer matrix composites. More brittle and stiffer fibers along with different organic tackifier constituent resin of the ceramic fibers require different methods of processing during manufacture of ceramic matrix composite structures.

A typical ceramic matrix composite structure is manufactured using a hand-layup process. A drawback in using a hand-layup process to manufacture a ceramic matrix composite structure is variability of quality and consistency of the ceramic matrix composite structure. As such, manual inspection and rework are often required. Another drawback is that the hand-layup process is time-intensive and requires skilled technicians. The overall result is increased cycle time as well as increased labor costs to manufacture the ceramic matrix composite structure.

Despite advances already made, those skilled in the art continue with research and development efforts in the field of manufacturing ceramic matrix composite structures.

### SUMMARY

In one aspect, an electronically-controlled method is provided for manufacturing a non-polymer structure with a desired shape. The electronically-controlled method comprises transporting a stack comprising of at least a first non-polymer ply and a second non-polymer ply from a surface at a first location to a tool surface at a second location, which is different from the first location, to enable the stack of at least the first non-polymer ply and the second non-polymer ply to be manufactured as the non-polymer structure with the desired shape at the second location.

In another aspect, an electronically-controlled method is provided for manufacturing a ceramic matrix composite structure with a desired shape. The electronically-controlled method comprises processing at a first location a plurality of ceramic matrix composite plies to form a stack of the plurality of ceramic matrix composite plies. The electronically-controlled method also comprises transporting the stack of plurality of ceramic matrix composite plies from the first location to a second location which is remote from the first location. The electronically-controlled method further comprises processing at the second location the stack of plurality of ceramic matrix composite plies to provide the ceramic matrix composite structure with the desired shape.

In yet another aspect, an electronically-controlled method is provided for manufacturing a ceramic matrix composite structure with a desired shape. The electronically-controlled method comprises picking a first ceramic matrix composite ply that is sandwiched between a first bottom backing film and a first top backing film, and placing the first ceramic matrix composite ply on a table surface at a first location. The electronically-controlled method also comprises peeling away the first top backing film from a top surface of the first ceramic matrix composite ply, and picking a second ceramic matrix composite ply that is sandwiched between a second bottom backing film and a second top backing film. The electronically-controlled method further comprises peeling away the second bottom backing film from a bottom surface of the second ceramic matrix composite ply, and placing the bottom surface of the second ceramic matrix composite ply on the top surface of the first ceramic matrix composite ply to form a stack of at least the first and second ceramic matrix composite plies. The electronically-controlled method also comprises transporting the stack of at least the first and second ceramic matrix composite plies from the table surface at the first location to a tool surface at a second location which is different from the first location to enable the stack of at least the first and second ceramic matrix composite plies to be manufactured as the ceramic matrix composite structure with the desired shape at the second location.

Other aspects will become apparent from the following detailed description, the accompanying drawings and the appended claims.

### BRIEF DESCRIPTION OF THE DRAWINGS

FIG. 1 is schematic block diagram of an apparatus for manufacturing a ceramic matrix composite structure in accordance with an embodiment.

FIG. 2A is an elevational view of a first non-polymer ply that is processed to provide a ceramic matrix composite structure.

FIG. 2B is an elevational view of a second non-polymer ply that is processed with the first non-polymer ply of FIG. 2A to provide a ceramic matrix composite structure.

FIGS. 3A-3M are elevational views showing certain components of the manufacturing apparatus of FIG. 1 in different positions during manufacture of a ceramic matrix composite structure.

FIG. 4A is an enlarged elevational view of an example stack of ceramic matrix composite plies provided in accordance with FIGS. 3A-3F.

FIG. 4B is an enlarged elevational view of an example compacted stack of ceramic matrix composite plies provided in accordance with FIGS. 3G-3I.

FIG. 5 is an enlarged elevational view of an example ceramic matrix composite structure manufactured in accordance with FIGS. 3J-3M.

FIG. 6 is an overall flow diagram depicting an example method for manufacturing a ceramic matrix composite structure in accordance with an embodiment.

FIG. 7 is a flow diagram depicting an example electronically-controlled method for manufacturing a non-polymer structure with a desired shape in accordance with an embodiment.

FIG. 8 is a flow diagram depicting an example electronically-controlled method for manufacturing a ceramic matrix composite structure with a desired shape in accordance with another embodiment.

FIG. 9 is a flow diagram depicting an example electronically-controlled method for manufacturing a ceramic matrix composite structure with a desired shape in accordance with yet another embodiment.

FIG. 10 is a flow diagram of an aircraft manufacturing and service methodology.

FIG. 11 is a block diagram of an aircraft.

### DETAILED DESCRIPTION

The present application is directed to ceramic matrix composite structures and methods for manufacture thereof. The specific construction of the ceramic matrix composite structures and methods for manufacture thereof and the industry in which the structures and methods are implemented may vary. It is to be understood that the disclosure below provides a number of embodiments or examples for implementing different features of various embodiments. Specific examples of components and arrangements are described to simplify the present disclosure. These are merely examples and are not intended to be limiting.

By way of example, the disclosure below describes ceramic matrix composite structures and methods for manufacturing at least a portion of an aircraft, such as an aircraft exhaust structure. The ceramic matrix composite structures and methods for manufacture thereof may be implemented by an original equipment manufacturer (OEM) in compliance with commercial, military, and space regulations. It is conceivable that the disclosed ceramic matrix composite structures and methods for manufacture thereof may be implemented in many other ceramic matrix composite manufacturing industries.

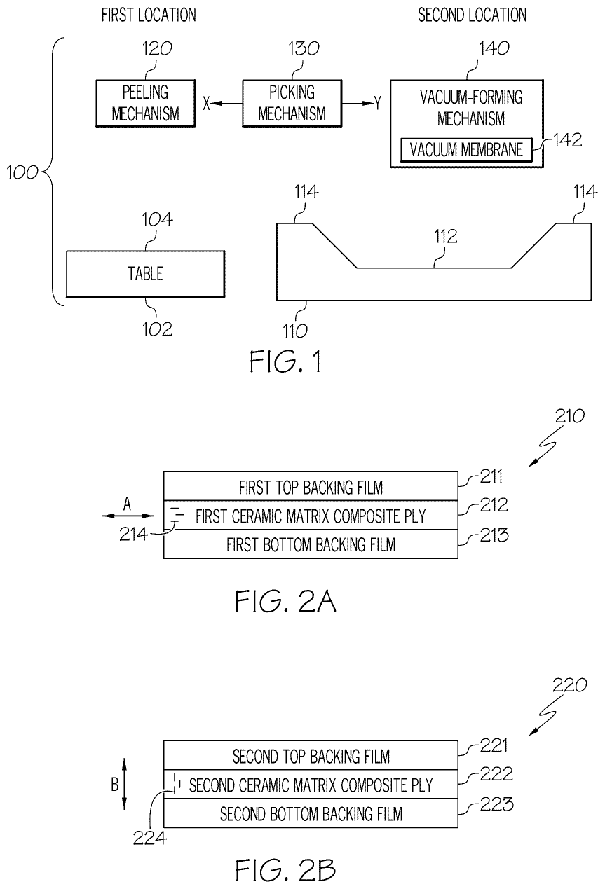

Referring to FIG. 1, a schematic block diagram of an apparatus 100 for manufacturing a ceramic matrix composite structure in accordance with an embodiment is illustrated. The apparatus 100 comprises a table 102 having a table surface 104 at a first location, and a tool 110 having a tool surface 112 at a second location which is different (i.e., remote) than the first location. The table surface 104 may comprise a releasable vacuum or electrostatics that is capable of holding a first ply of material in position on the table surface 104 while other plies of material are placed and compacted on that first ply. As an example, the table surface 104 may comprise a valve-actuated vacuum table. The tool surface 112 has optional steps 114 in vicinity of the perimeter of the tool 110. The apparatus 100 further comprises a number of mechanisms including a peeling mechanism 120, a picking mechanism 130, and a vacuum-forming mechanism 140. The peeling mechanism 120 is at the first location where the table 102 is located.

The picking mechanism 130 is a gripper end effector for picking and placing a sheet (e.g., a ply) of material on the table surface 104 of the table 102 or the tool surface 112 of the tool 110. The picking mechanism 130 may comprise electrostatic grippers or vacuum grippers, for example. The picking mechanism 130 is movable in opposite directions indicated by arrows X and Y between the first location where the table 102 is located and the second location where the tool 110 is located. The vacuum-forming mechanism 140 includes a vacuum membrane 142, and is located at the second location where the tool 110 is located. Structure and operation of peeling mechanisms, picking mechanisms, and vacuum-forming mechanism are known and conventional and, therefore, will not be described.

Although only one picking mechanism is shown in FIG. 1 (i.e., the picking mechanism 130), it is conceivable that two picking mechanisms be provided in which one picking mechanism is associated with the first location and the other picking mechanism is associated with the second location. It is also conceivable that two peeling mechanisms be provided, with one peeling mechanism being associated with the first location and the other peeling mechanism being associated with the second location. For simplicity and purpose of explanation, only one picking mechanism and only one peeling mechanism, as shown in FIG. 1, will be used and described herein.

Referring to FIG. 2A, an elevational view of a first non-polymer ply 210 that is processed to provide a ceramic matrix composite structure is illustrated. The first non-polymer ply 210 includes a first ceramic matrix composite ply 212 that is sandwiched between a first top backing film 211 and a first bottom backing film 213. The first ceramic matrix composite ply 212 has first fiber reinforcements 214 that are oriented in a first direction shown as arrow A in FIG. 2A. The first fiber reinforcements 214 comprise ceramic fibers, and the matrix is a ceramic-based material. Alternatively, the first ceramic matrix composite ply 212 may comprise a ceramic matrix composite ply having a fabric that is pre-impregnated with a matrix material, such as C_{f}/Si or SiC_{f}/SiC for example.

The first ceramic matrix composite ply 212 is a non-polymer material, and has a viscosity between about 3000 Poise and 7000 Poise. Tackiness of the first ceramic matrix composite ply 212 may vary as a function of an amount of water contained in the first ceramic matrix composite ply 212. Alternatively, tackiness of the first ceramic matrix composite ply 212 may vary as a function of an amount of solvent (e.g., non-water based) contained in the first ceramic matrix composite ply 212. Other water-based and non-water based compounds are possible. The weight of the first ceramic matrix composite ply 212 for a given volume of the first ceramic matrix composite ply 212 is less than weight of an equivalent volume of metal material, such as steel for example.

Referring to FIG. 2B, an elevational view of a second non-polymer ply 220 that is processed with the first non-polymer ply 210 of FIG. 2A to provide a ceramic matrix composite structure is illustrated. The second non-polymer ply 220 includes a second ceramic matrix composite ply 222 that is sandwiched between a second top backing film 221 and a second bottom backing film 223. The second ceramic matrix composite ply 222 has second fiber reinforcements 224 that are oriented in a second direction shown as arrow B in FIG. 2B. The second direction B of the second fiber reinforcements 224 is transverse (e.g., perpendicular) to the first direction A of the first fiber reinforcements 214. It is conceivable that the second direction B of the second fiber reinforcements 224 be non-transverse (e.g., parallel) to the first direction A of the first fiber reinforcements 214. The second fiber reinforcements 224 comprise ceramic fibers, and the matrix is a ceramic-based material. Alternatively, the second ceramic matrix composite ply 222 may comprise a ceramic matrix composite ply having a fabric that is pre-impregnated with a matrix material, such as C_{f}/Si or SiC_{f}/SiC for example.

The second ceramic matrix composite ply 222 is a non-polymer material, and has a viscosity between about 3000 Poise and 7000 Poise. Tackiness of the second ceramic matrix composite ply 222 may vary as a function of an amount of water contained in the second ceramic matrix composite ply 222. Alternatively, tackiness of the second ceramic matrix composite ply 222 may vary as a function of an amount of solvent (e.g., non-water based) contained in the second ceramic matrix composite ply 222. Other water-based and non-water based compounds are possible. The weight of the second ceramic matrix composite ply 222 for a given volume of the second ceramic matrix composite ply 222 is less than weight of an equivalent volume of metal material, such as steel for example.

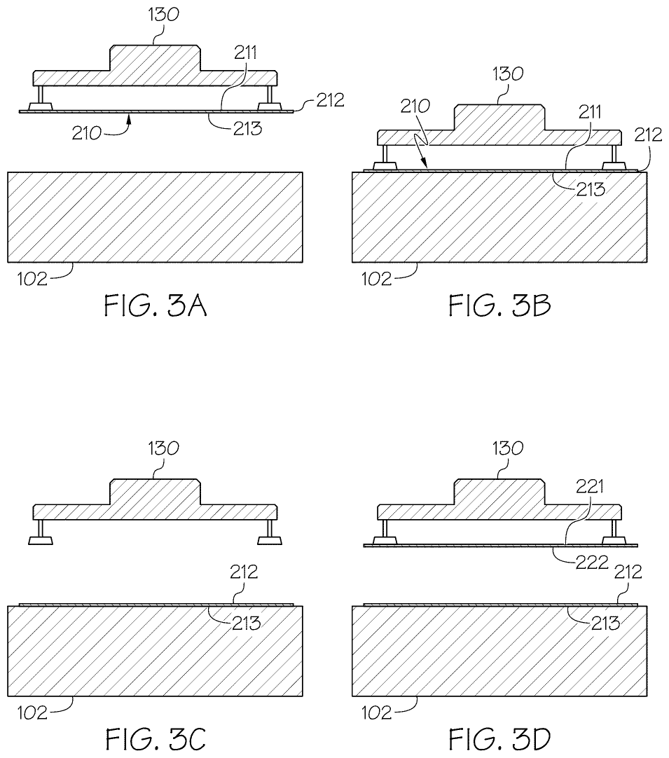

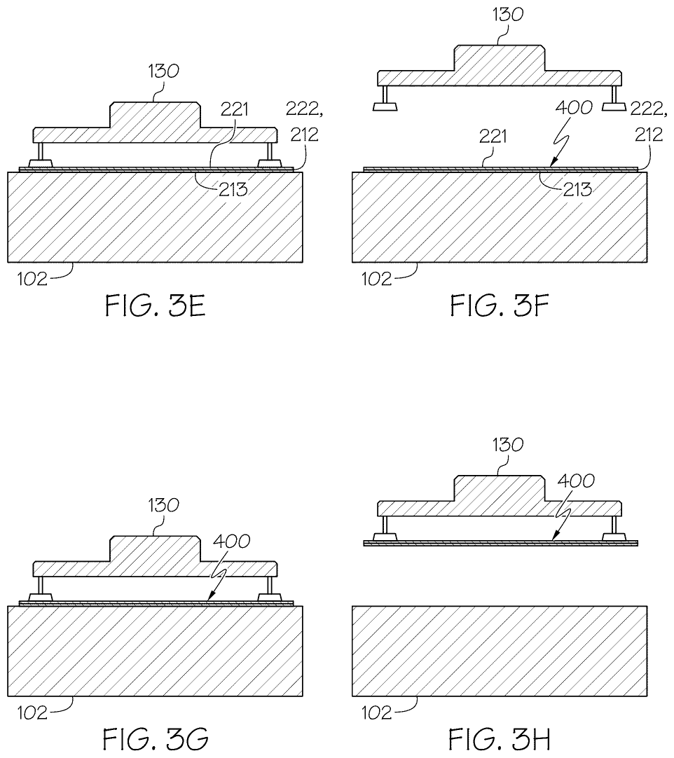

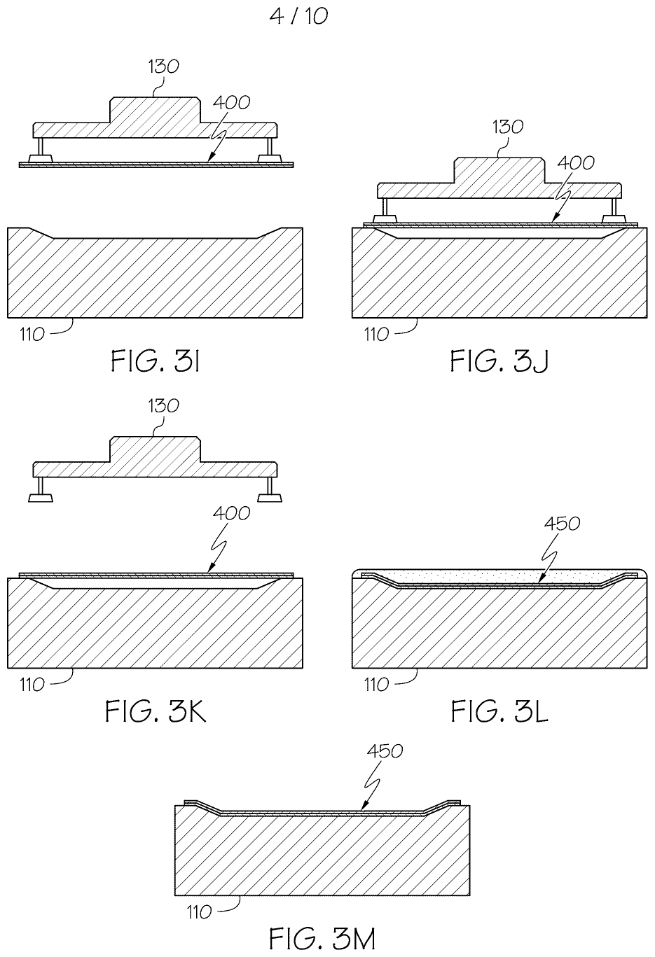

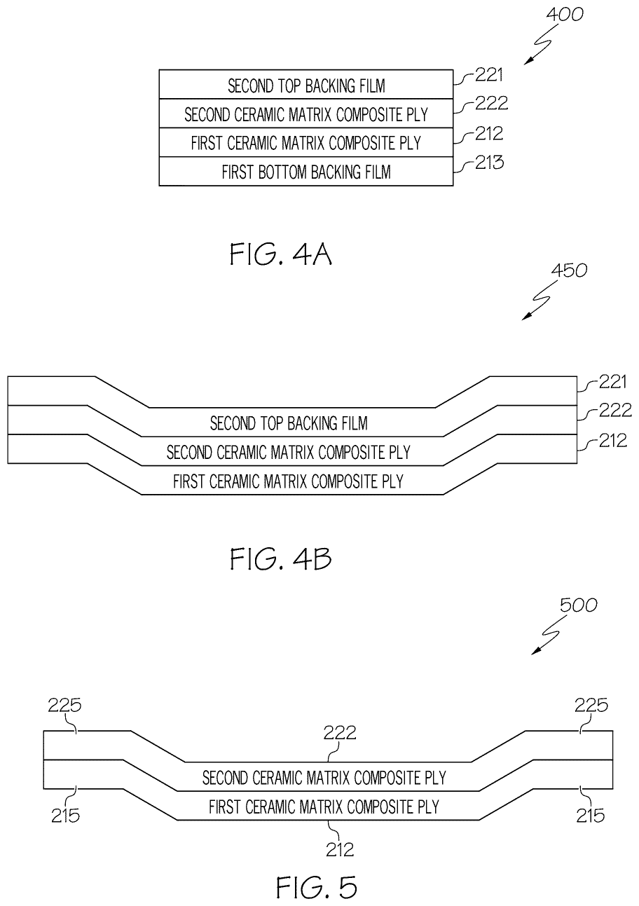

Referring to FIGS. 3A-3M, elevational views show certain components of the manufacturing apparatus 100 of FIG. 1 in different positions during manufacture of a ceramic matrix composite structure. From an overview, FIGS. 3A-3F show the first non-polymer ply 210 and the second material ply 220 of FIGS. 2A and 2B being processed to provide a stack 400 (shown in FIG. 4A) that comprises the second top backing film 221, the first and second ceramic matrix composite plies 212, 222, and the first bottom backing film 213. FIGS. 3G-3I show the stack 400 being processed to transport the stack 400 from the table 102 at the first location to the tool 110 at the second location. FIGS. 3J-3M show the stack 400 being processed to provide a compacted stack 450 (shown in FIG. 4B) and thereby to manufacture a ceramic matrix composite structure (shown in FIG. 5) that comprises the first and second ceramic matrix composite plies 212, 222 shaped as shown in FIG. 5.

As shown in FIG. 3A, the picking mechanism 130 is picking up the first non-polymer ply 210 (FIG. 2A) comprising the first ceramic matrix composite ply 212, the first bottom backing film 213, and the first top backing film 211. As shown in FIG. 3B, the picking mechanism 130 lowers the first non-polymer ply 210 onto the table 102. The picking mechanism 130 is then lifted away from the table 102 and the peeling mechanism 120 removes the first top backing film 211, as shown in FIG. 3C, leaving behind the first ceramic matrix composite ply 212 and the first bottom backing film 213 on the table 102. Then, after the peeling mechanism 120 removes the second bottom backing film 223 from the second material ply 220, the second ceramic matrix composite ply 222 along with the second top backing film 221 is positioned over the table 102, as shown in FIG. 3D. Thus, the picking mechanism 130 in FIG. 3D is holding up the second ceramic matrix composite ply 222 and the second top backing film 221.

As shown in FIG. 3E, the picking mechanism 130 lowers the second ceramic matrix composite ply 222 and the second top backing film 221 onto the first ceramic matrix composite ply 212 that is already on the table 102 to compact together the first and second ceramic composite plies 212, 222. The picking mechanism 130 is then lifted away from the table 102 as shown in FIG. 3F, leaving behind the stack 400 (FIG. 4A) that comprises the second ceramic matrix composite ply 222 and the second top backing film 221 on top of the first ceramic matrix composite ply 212 and the first bottom backing film 213. Sufficient pressure is applied on the stack 400 to enable handling of the stack 400, but not too much to prevent forming of the stack 400 to a final tool contour.

Then, the picking mechanism 130 is lowered onto the stack 400 as shown in FIG. 3G to lift the stack 400 away from the table 102 as shown in FIG. 3H. The picking mechanism 130 then moves from the first location where the table 102 is located, as shown in FIG. 3H, to the second location where the tool 110 is located, as shown in FIG. 3I.

After the first bottom backing film 213 is removed (which is optional at this manufacturing point), the picking mechanism 130 then lowers the stack 400 (minus the first bottom backing film 213 if it has been removed) onto the tool 110 as shown in FIG. 3J. After the picking mechanism 130 is lifted away as shown in FIG. 3K, the vacuum membrane 142 (FIG. 1) is positioned over the tool 110, referred to as “bagging” the stack 400 with the vacuum membrane 142. The vacuum-forming mechanism 140 applies a vacuum to compact the stack 400 of FIG. 4A (minus the first bottom backing film 213 if it has been removed) to the shape of the tool 110 to provide a compacted stack 450, as shown in FIG. 3L. The compacted stack 450 is shown enlarged in FIG. 4B.

After the stack 400 of FIG. 4A (minus the first bottom backing film 213 if it has been removed) is formed to the shape of the tool 110 to provide the compacted stack 450 of FIG. 4B, the vacuum and the vacuum membrane 142 are removed, leaving behind the compacted stack 450 on the tool 110, as shown in FIG. 3M. Thus, the compacted stack 450 shown in FIG. 3M and FIG. 4B is formed to the shape of the tool 110.

When the second top backing film 221 is removed from the compacted stack 450, the result is a ceramic matrix composite structure 500 as shown in FIG. 5. The ceramic matrix composite structure 500 comprises the shaped second ceramic matrix composite ply 222 and the shaped first ceramic matrix composite ply 212. The first fiber reinforcements 214 (FIG. 2A) of the first ceramic matrix composite ply 212 and the second fiber reinforcements 224 (FIG. 2B) of the second ceramic matrix composite ply 222 are oriented relative to each other during placement of the first and second ceramic matrix composite plies 212, 222 onto the table 102 at the first location such that the first and second fiber reinforcements 214, 224 reinforce each other.

In the ceramic matrix composite structure 500, the shaped first ceramic matrix composite ply 212 has optional flanges 215, and the shaped second ceramic matrix composite ply 222 has optional flanges 225. The optional flanges 215, 225 depend upon shape of the tool surface 112 of the tool 110, and whether the optional steps 114 (FIG. 1) are provided in vicinity of the perimeter of the tool 110. The optional flanges 215, 225 provide an attachment interface for installing the ceramic matrix composite structure 500.

As an example, an aircraft part or a portion of an aircraft may comprise the ceramic matrix composite structure 500 including the optional flanges 215, 225. Aircraft includes missiles, launch vehicles, high-speed aircraft, and rockets, for example. Aircraft parts include engine exhaust structures, for example. Other types of aircraft and other aircraft parts or systems are possible.

Although the above-described example ceramic matrix composite structure 500 contains two plies (i.e., the first ceramic matrix composite ply 212 and the second ceramic matrix composite ply 222), it is conceivable that a ceramic matrix composite structure contains three or more plies. It is also conceivable that a ceramic matrix composite structure contains only one ply.

Also, although the above description describes the first bottom backing film 213 being removed prior to the stack 400 of FIG. 4A being compacted to the shape of the tool 110, it is conceivable that the first bottom backing film 213 be removed after the stack 400 has been compacted. For example, the compacted stack 450 of FIG. 4B plus the first bottom backing film 213 (assuming that the first bottom backing film 213 was not previously removed) may need to be moved to a curing tool at another location to allow the compacted stack 450 to cure. In this case, the first bottom backing film 213 can be removed after the compacted stack 450 has been formed.

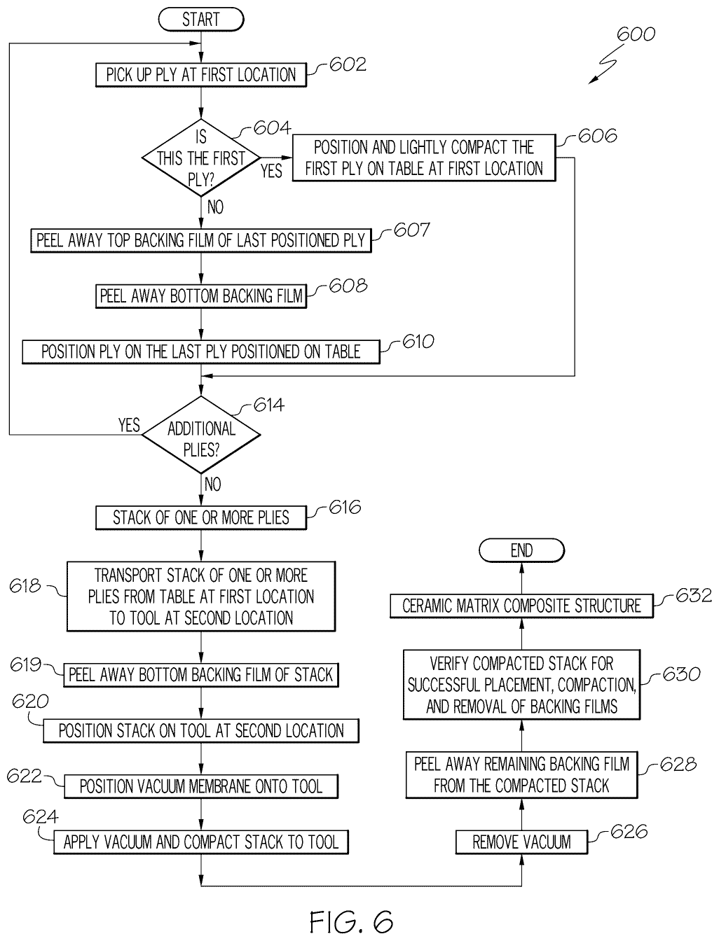

Referring to FIG. 6, an overall flow diagram 600 depicts an example method for manufacturing a ceramic matrix composite structure in accordance with an embodiment. In block 602, a ceramic matrix composite ply is picked up at a first location before proceeding to block 604. In block 604, a determination is made as to whether the ceramic matrix composite ply picked up in block 602 is the first ply picked. If the determination in block 604 is affirmative (i.e., it is the first ply picked), the process proceeds to block 606 in which the first ply picked is positioned and lightly compacted on a table at the first location before the process proceeds to block 614.

However, if the determination back in block 604 is negative (i.e., it is not the first ply picked), the process proceeds to block 607 to peel away a top backing film of the last ply that was positioned on the table at the first location. The process then proceeds to block 608 in which a bottom backing film of the picked ply of block 602 is peeled away. Then in block 610, the picked ply from block 602 is positioned on the last ply that was positioned on the table. The process proceeds to block 614.

In block 614, a determination is then made as to whether another ceramic matrix composite ply is to be added for the manufacturing of the ceramic matrix composite structure. If the determination in block 614 is affirmative (i.e., another ceramic matrix composite ply is to be added), the process returns to block 602 to process the next ceramic matrix composite ply. However, if the determination in block 614 is negative (i.e., there is no additional ceramic matrix composite ply), the process proceeds to block 616 in which a stack of one or more ceramic matrix composite plies is provided. The process then proceeds to block 618.

In block 618, the stack of one or more plies from block 616 is transported (i.e., moved) from the first location where the table is located to a second location where a tool is located. After a bottom backing film of the stack is removed, as shown in block 619, the stack of one or more plies is positioned on the tool at the second location, as shown in block 620.

A vacuum membrane is positioned on the tool at block 622, and a vacuum is then applied, as shown in block 624, to compact the stack of ceramic matrix composite plies to the tool. The process proceeds to block 626 in which the vacuum is removed before any remaining backing film including the top backing film of the last positioned ply is peeled away from the compacted stack as shown in block 628. The process proceeds to block 630 in which in-situ inspection is provided to verify the compacted stack for successful placement, compaction, and removal of backing films. After inspection, the process proceeds to block 632 in which the ceramic matrix composite structure is provided. The ceramic matrix composite structure contains at least one ceramic matrix composite ply plus any ceramic matrix composite plies added in block 614. The process then ends.

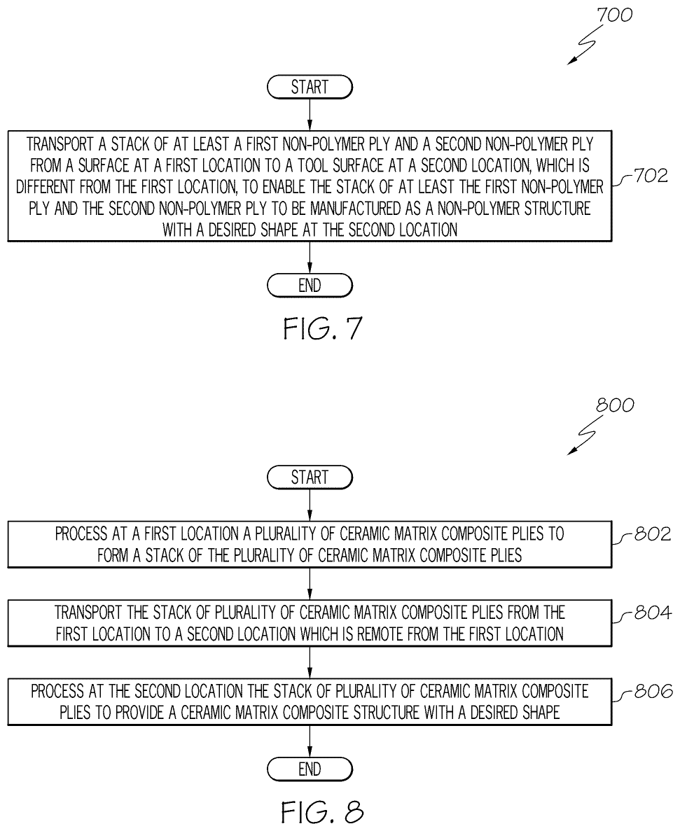

Referring to FIG. 7, a flow diagram 700 depicts an example electronically-controlled method for manufacturing a non-polymer structure with a desired shape in accordance with an embodiment. In block 702, a stack of at least first and second non-polymer plies of material is transported from a surface at a first location to a tool surface at a second location which is different from the first location to enable the stack of at least first and second non-polymer plies of material to be manufactured as the non-polymer structure with the desired shape at the second location. The process then ends.

Referring to FIG. 8, a flow diagram 800 depicts an example electronically-controlled method for manufacturing a ceramic matrix composite structure with a desired shape in accordance with another embodiment. In block 802, a plurality of ceramic matrix composite plies is processed at a first location to form a stack of the plurality of ceramic matrix composite plies. The process proceeds to block 804 in which the stack of plurality of ceramic matrix composite plies is transported from the first location to a second location which is remote from the first location. Then, in block 806, the stack of plurality of ceramic matrix composite plies is processed at the second location to provide the ceramic matrix composite structure with the desired shape. The process then ends.

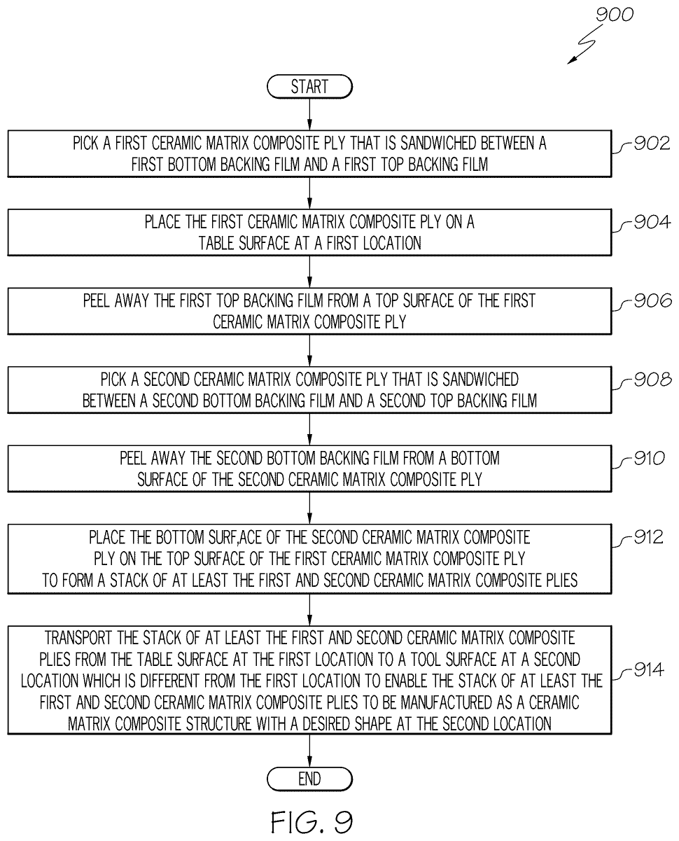

Referring to FIG. 9, a flow diagram 900 depicts an example electronically-controlled method for manufacturing a ceramic matrix composite structure with a desired shape in accordance with another embodiment. In block 902, a first ceramic matrix composite ply that is sandwiched between a first bottom backing film and a first top backing film is picked. Then in block 904, the first ceramic matrix composite ply is placed on a table surface at a first location. The process proceeds to block 906 in which the first top backing film is peeled away from a top surface of the first ceramic matrix composite ply. The process proceeds to block 908.

In block 908, a second ceramic matrix composite ply that is sandwiched between a second bottom backing film and a second top backing film is picked. Then, in block 910, the second bottom backing film is peeled away from a bottom surface of the second ceramic matrix composite ply before proceeding to block 912.

In block 912, the bottom surface of the second ceramic matrix composite ply is placed on the top surface of the first ceramic matrix composite ply to form a stack of at least the first and second ceramic matrix composite plies. Then, in block 914, the stack of at least the first and second ceramic matrix composite plies is transported from the table surface at the first location to a tool surface at a second location which is different from the first location to enable the stack of at least first and second ceramic matrix composite plies to be manufactured as the ceramic matrix composite structure with the desired shape at the second location.

A number of advantages result by providing the above-described ceramic matrix composite structures (e.g., the ceramic matrix composite structure 500 shown in FIG. 5) and the manufacturing methods therefor. One advantage is that the laying up of ceramic matrix composite plies onto a tool is a fully automated process. Placement and compaction of plies are automated, and in-situ inspection of quality measures is provided. Quality measures that can be inspected in-situ include, but are not limited to, ply location, fiber orientation, un-compacted regions, rework path determination, and large defects of different types and sizes.

Another advantage is that both first time quality and final product consistency are improved since placement and compaction of ceramic matrix composite plies onto a tool are automated. The result is reduced rework, reduced touch labor, reduced cycle time, and therefore reduced overall manufacturing costs.

Yet another advantage is that weight of a structure made of a ceramic-based material (e.g., the ceramic matrix composite structure 500 of FIG. 5) is less than weight of the same structure made of a non-ceramic-based material, such as metal for example. Moreover, the capability of the ceramic-based material to withstand high temperatures during operational use of the structure is much higher than the capability of non-ceramic-based materials to withstand the same high temperatures. A ceramic-based material is capable of withstanding temperatures up to 2400 degrees Fahrenheit. The high-temperature capability of the ceramic-based material allows a structure made of this material, such as a heat-shielding aircraft part or an aircraft exhaust structure, to be exposed to constant high temperatures (e.g., 1500 degrees Fahrenheit which is beyond limitation for most metals) during operational use of the structure. Thus, not only do ceramic matrix composite structures manufactured in accordance with the present disclosure have desirable weight advantages, but also have desirable thermal characteristics in applications where weight and thermal characteristics are considered important.

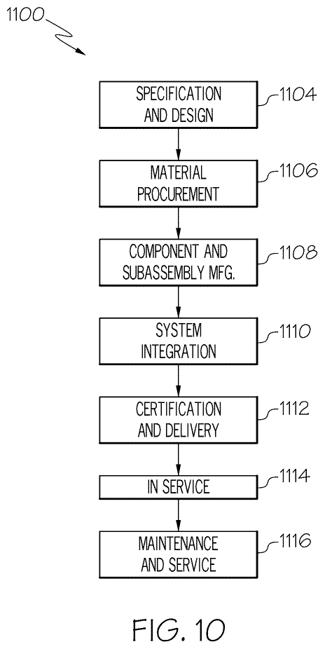

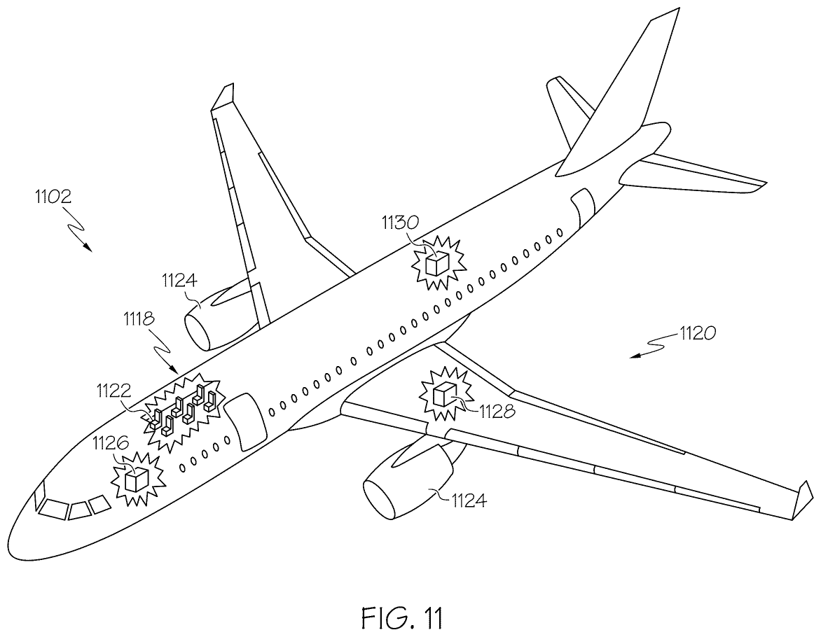

Examples of the disclosure may be described in the context of an aircraft manufacturing and service method 1100, as shown in FIG. 10, and an aircraft 1102, as shown in FIG. 11. During pre-production, the aircraft manufacturing and service method 1100 may include specification and design 1104 of the aircraft 1102 and material procurement 1106. During production, component/subassembly manufacturing 1108 and system integration 1110 of the aircraft 1102 takes place. Thereafter, the aircraft 1102 may go through certification and delivery 1112 in order to be placed in service 1114. While in service by a customer, the aircraft 1102 is scheduled for routine maintenance and service 1116, which may also include modification, reconfiguration, refurbishment and the like.

Each of the processes of method 1100 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 11, the aircraft 1102 produced by example method 1100 may include an airframe 1118 with a plurality of systems 1120 and an interior 1122. Examples of the plurality of systems 1120 may include one or more of a propulsion system 1124, an electrical system 1126, a hydraulic system 1128, and an environmental system 1130. Any number of other systems may be included.

The disclosed apparatus and method may be employed during any one or more of the stages of the aircraft manufacturing and service method 1100. As one example, components or subassemblies corresponding to component/subassembly manufacturing 1108, system integration 1110, and/or maintenance and service 1116 may be assembled using the disclosed apparatus method. As another example, the airframe 1118 may be constructed using the disclosed apparatus and method. Also, one or more apparatus examples, method examples, or a combination thereof may be utilized during component/subassembly manufacturing 1108 and/or system integration 1110, for example, by substantially expediting assembly of or reducing the cost of an aircraft 1102, such as the airframe 1118 and/or the interior 1122. Similarly, one or more of system examples, method examples, or a combination thereof may be utilized while the aircraft 1102 is in service, for example and without limitation, to maintenance and service 1116.

Aspects of disclosed embodiments may be implemented in software, hardware, firmware, or a combination thereof. The various elements of the system, either individually or in combination, may be implemented as a computer program product (program of instructions) tangibly embodied in a machine-readable storage device (storage medium) for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

The above-described apparatus and method are described in the context of an aircraft. However, one of ordinary skill in the art will readily recognize that the disclosed apparatus and method are suitable for a variety of applications, and the present disclosure is not limited to aircraft manufacturing applications. For example, the disclosed apparatus and method may be implemented in various types of vehicles including, for example, helicopters, passenger ships, automobiles, marine products (boat, motors, etc.) and the like. Non-vehicle applications are also contemplated.

Also, although the above-description describes an apparatus and method for manufacturing a ceramic matrix composite structure for an airplane part in the aviation industry in accordance with military and space regulations, it is contemplated that the apparatus and method may be implemented to facilitate manufacturing a ceramic matrix composite structure in any industry in accordance with the applicable industry standards. The specific apparatus and method can be selected and tailored depending upon the particular application.

Further, although various aspects of disclosed embodiments have been shown and described, modifications may occur to those skilled in the art upon reading the specification. The present application includes such modifications and is limited only by the scope of the claims.

1. An electronically-controlled method for manufacturing a ceramic matrix composite structure with a desired shape, the electronically-controlled method comprising:
processing at a first location a first ceramic matrix composite ply and a second ceramic matrix composite ply to form a stack, wherein the processing comprises:
peeling away a top backing film from a top surface of the first ceramic matrix composite ply;
peeling away a bottom backing film from a bottom surface of the second ceramic matrix composite ply; and
after the peeling away the bottom backing film, placing the bottom surface of the second ceramic matrix composite ply on top of the top surface of the first ceramic matrix composite ply;
transporting the stack from the first location to a second location, which is remote from the first location; and
processing the stack at the second location to yield the ceramic matrix composite structure with the desired shape.

2. The electronically-controlled method of claim 1 further comprising positioning at the second location a vacuum membrane against the stack to provide a vacuum-tight seal against the stack.

3. The electronically-controlled method of claim 2 further comprising drawing a vacuum to pull the vacuum membrane against the stack.

4. (canceled)

5. The electronically-controlled method of claim 1 wherein each of the first ceramic matrix composite ply and the second ceramic matrix composite ply comprises a matrix and fiber reinforcements within the matrix.

6. The electronically-controlled method of claim 5 wherein the matrix comprises a ceramic based material, and the fiber reinforcements within the matrix comprise ceramic fibers.

7. The electronically-controlled method of claim 1 wherein each of the first ceramic matrix composite ply and the second ceramic matrix composite ply comprises a fabric that is pre-impregnated with a matrix material.

8. The electronically-controlled method of claim 1 further comprising orientating fiber reinforcements of each of the first ceramic matrix composite ply and the second ceramic matrix composite ply such that the fiber reinforcements reinforce each other when the ceramic matrix composite structure with the desired shape is manufactured.

9-11. (canceled)

12. An electronically-controlled method for manufacturing a ceramic matrix composite structure with a desired shape, the electronically-controlled method comprising:
picking a first ceramic matrix composite ply that is sandwiched between a first bottom backing film and a first top backing film;
placing the first ceramic matrix composite ply on a table surface at a first location;
peeling away the first top backing film from a top surface of the first ceramic matrix composite ply;
picking a second ceramic matrix composite ply that is sandwiched between a second bottom backing film and a second top backing film;
peeling away the second bottom backing film from a bottom surface of the second ceramic matrix composite ply;
placing the bottom surface of the second ceramic matrix composite ply on the top surface of the first ceramic matrix composite ply to form a stack comprising at least the first ceramic matrix composite ply and the second ceramic matrix composite ply; and
transporting the stack from the table surface at the first location to a tool surface at a second location which is different from the first location to enable the stack to be manufactured as the ceramic matrix composite structure with the desired shape at the second location.

13. The electronically-controlled method of claim 12 further comprising:
prior to transporting the stack from the table surface at the first location to the tool surface at the second location, peeling away the first bottom backing film from a bottom surface of the first ceramic matrix composite ply.

14. The electronically-controlled method of claim 12 further comprising:
after transporting the stack from the table surface at the first location to the tool surface at the second location, forming shape of the stack to shape of the tool surface, and then peeling away the first bottom backing film from a bottom surface of the first ceramic matrix composite ply.

15-17. (canceled)

18. The electronically-controlled method of claim 12 wherein (i) picking a first ceramic matrix composite ply that is sandwiched between a first bottom backing film and a first top backing film includes picking a first ceramic matrix composite ply having a first matrix and fiber reinforcements within the first matrix, and (ii) picking a second ceramic matrix composite ply that is sandwiched between a second bottom backing film and a second top backing film includes picking a second ceramic matrix composite ply having a second matrix and fiber reinforcements within the second matrix.

19. The electronically-controlled method of claim 18 wherein each of the first matrix and the second matrix comprises a ceramic based material, and the fiber reinforcements within the first matrix and the second matrix comprise ceramic fibers.

20. The electronically-controlled method of claim 12 wherein (i) picking a first ceramic matrix composite ply that is sandwiched between a first bottom backing film and a first top backing film includes picking a first ceramic matrix composite ply having a first fabric that is pre-impregnated with a matrix material, and (ii) picking a second ceramic matrix composite ply that is sandwiched between a second bottom backing film and a second top backing film includes picking a second ceramic matrix composite ply having a second fabric that is pre-impregnated with a matrix material.

21. The electronically-controlled method of claim 18 further comprising:
orientating fiber reinforcements of each of the first ceramic matrix composite ply and the second ceramic matrix composite ply during placement of the first ceramic matrix composite ply and the second ceramic matrix composite ply on the table surface at the first location such that the fiber reinforcements reinforce each other when the ceramic matrix composite structure with the desired shape is manufactured.

22-24. (canceled)

25. An electronically-controlled method for manufacturing a non-polymer structure with a desired shape, the electronically-controlled method comprising:
transporting a stack comprising at least a first non-polymer ply and a second non-polymer ply from a table surface at a first location to a tool surface at a second location, which is different from the first location, to enable the stack of at least the first non-polymer ply and the second non-polymer ply to be manufactured as the non-polymer structure with the desired shape at the second location.

26. The electronically-controlled method of claim 25 wherein the transporting the stack of at least the first non-polymer ply and the second non-polymer ply from the table surface at the first location to the tool surface at the second location comprises:
transporting the stack of at least the first non-polymer ply and the second non-polymer ply from the table surface at the first location to the tool surface at the second location, wherein the first non-polymer ply and the second non-polymer ply comprise a ceramic matrix composite.

27-28. (canceled)

29. The electronically-controlled method of claim 25 wherein the transporting the stack of at least the first non-polymer ply and the second non-polymer ply from the table surface at the first location to the tool surface at the second location includes:
transporting a stack of at least the first non-polymer ply and the second non-polymer ply having a fabric that is pre-impregnated with a matrix material from the table surface at the first location to the tool surface at the second location.

30. (canceled)

31. The electronically-controlled method of claim 25 further comprising:
applying a vacuum to the stack of at least the first non-polymer ply and the second non-polymer ply to form a shaped stack that conforms to a shape of the tool surface and thereby to provide the non-polymer structure with the desired shape.

32-35. (canceled)

36. The electronically-controlled method of claim 25 wherein weight of the non-polymer structure for a given volume of the non-polymer structure is less than weight of an equivalent volume of a metal structure.

37-39. (canceled)

40. The electronically-controlled method of claim 1 further comprising vacuum compacting the stack.
